(19) United States
(12) Patent Application Publication
(10) Pub. No.: US 2026/0118325 A1
(43) Pub. Date: Apr. 30, 2026

(54) ANALYSIS DEVICE WITH PARALLEL OPERATION OF SECONDARY FUNCTIONS

(71) Applicant: Agilent Technologies, Inc., Santa Clara, CA (US)

(72) Inventors: Stefan Mittrich, Kapsweyer (DE); Timo Witte, Waldbronn (DE); Kyle Robert Busch, Karlsruhe (DE); Udo Herynek, Oetisheim (DE)

(21) Appl. No.: 19/369,081

(22) Filed: Oct. 24, 2025

(30) Foreign Application Priority Data
Oct. 25, 2024 (DE) 102024131201.7

(51) Int. Cl. G01N 30/88

(52) U.S. Cl. CPC G01N 30/88; G01N 2030/889

(57) ABSTRACT

An analysis device, in particular for a sample separation device, for performing an analysis, is configured for executing a primary function which is directly associated with performing the analysis, and executing a first secondary function and a second secondary function which are indirectly associated with performing the analysis. The first secondary function and the second secondary function are performed at least temporarily in parallel with one another.

### CROSS-REFERENCE TO RELATED APPLICATIONS

The present application claims the benefit of German Patent Application No. DE 102024131 201.7, filed on October 25, 2024, which is incorporated herein by reference in its entirety.

### TECHNICAL FIELD

The present disclosure relates to an analysis device (in particular a sample separation device) for performing an analysis, wherein the analysis device is configured for executing a primary function (which is directly associated with performing the analysis) and executing a first secondary function and a second secondary function (which are indirectly associated with performing the analysis), wherein the first secondary function and the second secondary function are performed at least temporarily in parallel with one another. The present disclosure further relates to a computer-implemented method for operating an analysis device, and a device for data processing which can carry out the method.

### BACKGROUND

Analysis devices such as sample separation devices are provided for the analysis of a sample, in particular a fluidic sample, e.g. for performing a chromatographic separation of the sample. For example in an HPLC (high-performance liquid chromatography) analysis device, a liquid (mobile phase) is moved at a very precisely controlled flow rate (for example in the range of microliters to milliliters per minute) and at a high pressure (typically 20 to 1000 bar and above, currently up to 2000 bar), at which the compressibility of the liquid can be noticeable, through a so-called stationary phase (for example in a chromatographic column), in order to separate individual fractions of a sample liquid introduced into the mobile phase from one another. After passing through the stationary phase, the separated fractions of the fluidic sample are detected in a detector. Such an HPLC system is known for example from EP 0,309,596 B1 of the same applicant, Agilent Technologies, Inc., the entire contents of which are incorporated herein by reference.

In addition to the primary functions of the analysis device which relate to the actual performance of the analysis (in an HPLC e.g. flowing a mobile phase with a fluidic sample through the sample separation device), however, a plurality of secondary functions are also necessary for operating the analysis device. Secondary functions are not directly associated with performing the analysis, i.e. relate in particular to maintenance and system tests (diagnostics). However, performing the secondary functions can be very time-consuming and thereby oppose efficient operation of the analysis device. Time-intensive operation can inevitably also lead to higher personnel costs (e.g. service technicians).

### SUMMARY

There may be a need to operate an analysis device (time-) efficiently.

According to a first exemplary embodiment of the present disclosure, an analysis device is described (in particular a sample separation device such as e.g. an HPLC device) for performing an analysis (e.g. separating a fluidic sample), configured for

i) executing a primary function which is directly associated with performing the analysis (or comprises the analysis of the fluidic sample); and

ii) executing a first secondary function and a second secondary function (wherein the first secondary function differs from the second secondary function) which are indirectly associated with performing the analysis (in particular do not comprise performing the analysis or are free from analyzing the fluidic sample).

Here, the first secondary function and the second secondary function are performed at least temporarily in parallel with one another (in terms of time) (or at least temporarily simultaneously).

According to a second exemplary embodiment of the present disclosure, a (computer-implemented) method for operating an analysis device (see above) is described, the method comprising: i) executing a primary function which is directly associated with performing the analysis; and ii) executing a first secondary function and a second secondary function which are indirectly associated with performing the analysis; wherein the first secondary function and the second secondary function are performed at least temporarily in parallel with one another.

According to a third exemplary embodiment of the present disclosure, a device for data processing (e.g. one or more processors) is described which is configured to carry out the method described above. The device for data processing can, in a simple example, comprise one or more processors. In a more complex example, the device for data processing can be a control device, in particular a central control device, of the analysis device. In one example, the control device can comprise central control software.

In the context of the present document, the term “primary function” denotes in particular that a function of an analysis device is directly associated with performing the analysis. In one example, a primary function is in particular directly associated with handling a fluidic sample. In one example, the primary function includes an (actual) analysis of the sample. In the example of an HPLC, a mobile phase which includes the fluidic sample is flowed through a chromatographic column. Primary functions of the HPLC are therefore e.g. injecting the fluidic sample into the mobile phase, flowing/pumping the mobile phase with the fluidic sample, separating the fluidic sample in the sample separation device, analyzing the separated fluidic sample. In a further example, however, a primary function can also encompass the flowing of the mobile phase through the main path (container, analytical pump, sample separation device, detector).

In the context of the present document, the term “secondary function” denotes in particular that a function of an analysis device is (only) indirectly associated with performing the analysis. In other words, the secondary function does not include performing an analysis (of the sample) or is free from analyzing the sample. A secondary function can relate e.g. to a diagnosis or a maintenance (e.g. start-up, shut-down, equilibration, and/or other automated procedure). Such functions relate to the operation of the analysis device, but not to the (actual) performance of the analysis. A secondary function can relate e.g. to a test, e.g. a system test or a function test (e.g. a pressure test). Furthermore, a secondary function can relate e.g. to exchanging a sample needle or a separation column. While some secondary functions are independent of one another, other secondary functions relate to the same hardware and are therefore functionally coupled. Furthermore, a secondary function can also have an operation of one or more system components in order to put the analysis device into a state required for the analysis of the sample (e.g. equilibration, ramp-up, etc.).

In the context of the present document, the term “in parallel with one another” denotes in particular that two or more processes are performed at least temporarily simultaneously. For example, the secondary function “system pressure test” can be performed simultaneously with the secondary function “intensity test of the detector”.

In the context of the present document, the term “fluid” denotes in particular a liquid and/or a gas, optionally comprising solid particles. The term “fluid” can also relate to a mobile phase in which a fluidic sample is transported. If the viscosity of a fluid is measured, this can be the viscosity of the fluid (mobile phase) itself or the viscosity of the fluidic sample in the mobile phase.

In the context of the present document, the term “fluidic sample” denotes in particular a medium, further in particular a liquid, which contains the matter actually to be analyzed (for example a biological sample), such as for example a protein solution, a pharmaceutical sample, etc.

In the context of the present document, the term “mobile phase” denotes in particular a fluid, further in particular a liquid, which serves as a carrier medium for transporting the fluidic sample between a fluid drive and a sample separation device. Mobile phase can, however, also be used in a fluid conveying device for influencing the fluidic sample. For example, the mobile phase can be a (for example organic and/or inorganic) solvent or a solvent composition (for example water and ethanol).

In the context of the present document, the term “analysis device” can denote in particular a device which is able and configured to examine, in particular to separate, a fluidic sample, further in particular to separate it into different fractions. For example, such a sample separation can be caused by means of chromatography or electrophoresis. The analysis device may be a liquid chromatography sample separation device.

According to an exemplary embodiment, the present disclosure can be based on the idea that an analysis device can be operated/organized especially in a time-efficient manner if secondary functions of the analysis device are performed simultaneously or in parallel with one another.

Conventional solutions only allow the sequential execution of secondary functions on the analysis device. For users, in particular experienced users such as service technicians, this is a disadvantage. The sequential execution takes a lot of time and therefore causes higher costs. It is always necessary to wait until a process is completed before the next process can be started.

The (at least temporarily) parallel execution of secondary functions such as system tests or maintenances can, however, lead to a significant time saving and to lower costs. For example, an analytical pump can be calibrated while at the same time a sample needle is exchanged and/or an intensity test of a detector lamp is performed. Each of these processes is time-consuming and until now a user has to execute them sequentially, i.e. always wait until a process is fully completed (the rest of the system is blocked in this time). According to the present disclosure, however, the user can e.g. already start with the exchange of the sample needle while the calibration of the pump and the test of the detector are running in time.

The parallel execution of the secondary functions may be organized centrally, whereby especially efficient operation can result. While some secondary functions are very well suited for being operated in parallel (e.g. because they are assigned to different modules of the analysis device), other secondary functions can relate to the same component and therefore cannot be executed simultaneously. Furthermore, e.g. test results of a first secondary function can be used directly for a second secondary function, so that additionally time and costs can be saved.

### EXEMPLARY EMBODIMENTS

According to an exemplary embodiment the first secondary function and/or the second secondary function comprises at least one of the following: a diagnosis, a maintenance, a fault search, a fault correction (trouble shooting), a problem solution, a configuration, an adjusting, a calibration, an equilibration, a cleaning, a rinsing, a replacement, a repair, an adjustment, a test. A test can be e.g. one of the following: a system test, a function test, a system check, a function check. These are some (non-exhaustive) examples of secondary functions which are/can be generally performed during the operation of an analysis device. Accordingly, the described analysis device can organize a plurality of processes in parallel and enable especially efficient operation.

According to an exemplary embodiment the primary function comprises a direct reference to the analysis of a (fluidic) sample. Such a direct reference can be e.g. one of the following processes: operating an analytical pump or flowing a mobile phase (which comprises the fluidic sample), operating a sample separation device or flowing the mobile phase (which comprises the fluidic sample) through the sample separation device, operating a sample receptacle (for receiving the fluidic sample), operating a detector (for analyzing the separated fluidic sample). The primary function can thus relate in particular to the analysis or separation of the fluidic sample. Secondary functions, on the other hand, have no direct reference to the fluidic sample in one example. In a further example, secondary functions do not encompass handling the sample to be analyzed.

According to an exemplary embodiment the analysis device comprises two or more modules. According to an exemplary embodiment the analysis device comprises two or more components. Here, the term “module” can relate to an individual unit of the analysis device. Here, the term “component” can relate to an independent or independently controllable element of the analysis device.

According to an exemplary embodiment the analysis device comprises at least one of the following modules: a pump module, a detector module, a sample separation module, a sample receptacle module. Analysis devices such as an HPLC are often constructed module-wise and/or component-wise. In this way, each module can be optimized for a specific task. Furthermore, a considerable space saving can be achieved e.g. by stacking the modules. The module-wise or component-wise organization can enable the parallel operation of secondary functions to be organized especially efficiently. For example, secondary functions may run in parallel with one another, which relate to different modules/components.

According to an exemplary embodiment the first secondary function and the second secondary function relate to different functions and/or different processes, in particular different modules/components, of the analysis device. This can have the advantage that different hardware is used for these secondary functions, so that there can be no interference between the secondary functions.

According to an exemplary embodiment the analysis device is further configured for determining which function of the analysis device is required by the first and/or second secondary function. According to an exemplary embodiment the analysis device is further configured for preventing or blocking (resource locking) this function for a further secondary function (in particular as long as the first and/or second secondary function is executed). Thereby, an especially efficient operation can be ensured. Even if the parallel operation of secondary functions saves time and costs, in one example not all secondary functions are equally suitable for being operated in parallel.

In an illustrative example (compare FIGS. 4A and 4B) a system pressure test is performed as the first secondary function. As a further secondary function the user wants to exchange the separation column simultaneously. In the system pressure test, however, the binary pump and the separation column are fluidically coupled so that an exchange of the column during the system pressure test is not possible. Accordingly, the function “fluid path between pump and column” can be blocked while the system pressure test is running. In other words, a mutual exclusion block on resources can be used (wherein resources can be hardware components, entire modules, or also virtual things (e.g. a running external procedure).

According to an exemplary embodiment the analysis device is further configured for determining which module and/or which component is required by the first and/or second secondary function. According to an exemplary embodiment the analysis device is further configured for blocking this module and/or this component (components can be found in the physical world (module, pump head etc.) but also be purely virtual constructs (e.g. user-defined flow path, a software part or the like)) for a further secondary function (in particular as long as the first and/or second secondary function is executed). An example was described above in which the “blocking” is performed functionally. Additionally or alternatively, the blocking can also be organized module-wise or component-wise. In an illustrative example (compare FIG. 4C) only one process is performed at once in the detector module; here the wavelength verification test has to wait until the intensity test is ended.

According to an exemplary embodiment the analysis device is further configured for comparing the first secondary function and the second secondary function. According to an exemplary embodiment the analysis device is further configured for comparing such that an action which has already been performed for the first secondary function is obsolete for the second secondary function. This can have the advantage that an especially efficient mode of operation is enabled in which repetitions can be excluded. For example, a measured pressure can be used for different secondary functions without being measured several times.

According to an exemplary embodiment, the analysis device is further configured for performing a scheduling (task scheduling) with respect to the first secondary function and the second secondary function. According to an exemplary embodiment the schedule includes when the first secondary function and/or the second secondary function (and/or the further secondary function) is available again. By means of the scheduling an order can be provided when which process (or which secondary function) is executed. While some secondary functions are executed in parallel with one another, other secondary functions must wait until corresponding resources are available.

According to an exemplary embodiment the analysis device is further configured for determining whether a further secondary function is active which may interfere with executing the first secondary function and/or the second secondary function (in particular performing the first secondary function and/or the second secondary function after the further secondary function has been performed). The reliability can be significantly increased if secondary functions which relate to or use the same component/assembly/resource/module are considered with respect to whether a mutual interference is possible. In the case that secondary functions may interfere with one another, they should not be operated in parallel with one another, but rather in succession. This can be implemented e.g. via a schedule efficiently in interaction with the parallel operation.

According to an exemplary embodiment the analysis device is further configured for influencing a flow path of the analysis device in order to enable the secondary functions to be executed in parallel. This can have the advantage that the parallel execution of secondary functions can be controlled in a targeted manner. According to an exemplary embodiment the influencing comprises at least one of blocking, diverting, coupling or decoupling, retracting or extending (e.g. retracting/extending a needle into/out of the needle seat), or interconnecting. Means for implementing the influencing can be e.g. valves. As a result, flow paths can be separated from one another, so that an execution of secondary function(s) in both flow paths or relating thereto can take place in parallel (so that a parallel execution of two separate procedures on the two flow paths is possible).

According to an exemplary embodiment the analysis device comprises a central control device. According to an exemplary embodiment the first secondary function and the second secondary function (in particular all secondary functions of the analysis device) are organized in the central control device. According to an exemplary embodiment the primary function, in particular all primary functions of the analysis device, are organized in the central control device. This can have the advantage that a plurality, in particular all, of the primary/secondary functions are bundled in a central control device, whereby an especially efficient operation can result. The bundling of the functions can enable a scheduling of the secondary functions, so that some processes are executed in parallel and other processes in series. Via the central control device a user can access the functions of the analysis device efficiently, even in remote operation. The control device can be implemented e.g. as part of the system control of the analysis device.

According to an exemplary embodiment the analysis device (in particular the central control device) has central control software. A user can organize the secondary functions and/or the primary functions of the analysis device via a user interface (of the control software). The user friendliness can thereby be increased.

According to an exemplary embodiment errors can be avoided by means of a central control device (overall system) and the reliability can be increased. The traceability can also be improved via the central organization.

According to an exemplary embodiment the user interface enables: detecting whether a secondary function is available or blocked. According to an exemplary embodiment the user interface enables: detecting when the execution of the first and the second secondary function will be completed. According to an exemplary embodiment the user interface enables: receiving a notification, e.g. in the user interface, as an e-mail, as a push notification, in the form of an acoustic or visual signal by the analysis device when a secondary function is completed and/or available again. The user can thus monitor a scheduling of the analysis device and intervene in the operation if necessary.

According to an exemplary embodiment the central control device is or comprises control software with a user interface in which the user can trigger, schedule and monitor the secondary and/or primary functions. In particular the user can detect in the user interface when a secondary function is not available (e.g. since current resources necessary for this are blocked) and when the execution of the first and/or second secondary function will be completed. In addition the user can be automatically notified by the system when a secondary function is completed or available again.

According to an exemplary embodiment the actuation/execution/monitoring of the different secondary functions (also primary functions) takes place (exclusively) only from one software instance (e.g. controller).

According to an exemplary embodiment the analysis device (in particular the central control device) can be operated at least partially in remote operation, in particular via a network (e.g. the internet). This can have the advantage that an especially efficient and user-friendly operation with reduced time requirement and lower costs is enabled.

According to an exemplary embodiment at least two of the following secondary functions are executed at least temporarily in parallel: calibrating an analytical pump (in particular system pressure test) (relates in particular to a fluid drive module), exchanging a sample needle and/or a needle seat (relates in particular to an injector module), intensity test of a detector lamp (can e.g. also be a diode/LED) or of the sensor, exchanging the light source (relates in particular to a detector module), exchanging a chromatographic column (relates in particular to a sample separation module or the column thermostat/oven). These examples relate to different modules of the analysis device and can thus be especially suitable for the parallel operation.

In an exemplary embodiment most (in particular all) detector tests can be performed in parallel with other secondary functions (e.g. module tests, calibrations, maintenance procedures). Such detector tests can comprise e.g. one of the following: cell test, DAC test, dark current test, filter test filter/grating motor test, holmium oxide test, intensity test, self-test, (optical) slit/slit test, wavelength calibration, wavelength verification test.

In an exemplary embodiment pump-internal secondary functions (e.g. tests/maintenance procedures) can be performed in parallel with detector tests and/or “exchanging a sample needle and/or a needle seat”. Such pump-internal functions can comprise e.g.: pump leak rate test, pump self-test, installing/assembling/removing the pump head, automatic seal wear-in procedure.

In an exemplary embodiment sampler/injector secondary functions (e.g. sampler calibrations, maintenance procedures) can be performed in parallel with detector tests and/or pump-internal tests. Sampler/injector secondary functions can comprise, e.g.: vial-sampler alignment teaching (axis calibration), vial-sampler gripper verification, ALS-torque verification, multi-sampler automatic referencing, maintenance positions, or sample cooler function test.

In an exemplary embodiment column thermostat/oven secondary functions can be performed in parallel with detector/pump-internal/sampler-internal secondary functions, e.g. thermostat test, thermostat calibration.

According to an exemplary embodiment the described software architecture enables sessions with multiple process executions and/or users, so that the user can execute different diagnosis and maintenance procedures in parallel. The user interface can enable the user to switch between the procedures and can highlight when a procedure running in the background requires user interaction. Users can start and execute diagnosis procedures on different modules in the device in parallel, so that they can work more efficiently and e.g. reduce the costs for on-site sessions for the company and the customer. As a side effect the user can display and control the processes in front of the device, on the laboratory PC or on a mobile device via the web interface.

In the context of the present application, the term “sample separation device” can denote in particular a device for analyzing a fluidic sample, in particular into different fractions. For this purpose components of the fluidic sample can first be adsorbed at the sample separation device and then desorbed separately (in particular fractionally). For example, such a sample separation device can be configured as a chromatographic separation column.

According to an exemplary embodiment the analysis device is a sample separation device, in particular a chromatography device, in particular a liquid chromatography device, a gas chromatography device, an SFC (supercritical liquid chromatography) device or an HPLC (high- performance liquid chromatography) device.

According to an exemplary embodiment the analysis device is configured as a microfluidic device. According to an exemplary embodiment the analysis device is configured as a nanofluidic device.

According to an exemplary embodiment the sample separation device is configured as a chromatographic separation device, in particular as a chromatographic separation column.

According to an exemplary embodiment the fluid drive is configured for driving the mobile phase and the fluidic sample under high pressure.

According to an exemplary embodiment the fluid drive is configured for driving the mobile phase and the fluidic sample at a pressure of at least 500 bar, in particular of at least 1000 bar, further in particular of at least 1200 bar, further in particular of at least 1500 bar.

According to an exemplary embodiment the analysis device comprises a detector for detecting the analyzed, in particular separated, fluidic sample.

According to an exemplary embodiment, the analysis device comprises a fractionator for fractionating separated fractions of the fluidic sample.

The analysis device can be a microfluidic measuring device, a life science device, a liquid chromatography device, a gas chromatography device, an HPLC (high-performance liquid chromatography) device, a UHPLC (ultra-high-performance liquid chromatography) device, or an SFC (supercritical liquid chromatography) device. However, many other applications are possible.

According to an exemplary embodiment the sample separation device can be configured as a chromatographic separation device, in particular as a chromatographic separation column. In a chromatographic separation the chromatographic separation column can be provided with an adsorption medium. At this the fluidic sample can be stopped and only subsequently in the presence of a specific solvent composition it can be fractionally detached again, whereby the separation of the sample into its fractions is accomplished.

A pumping system for conveying fluid can for example be configured for conveying the fluid or the mobile phase at a high pressure, for example a few 100 bar up to 1000 bar and more, through the system.

The analysis device can comprise a sample injector for introducing the sample into the fluidic separation path. Such a sample injector can comprise a sample or injection needle which can be coupled to a needle seat in a corresponding liquid path, wherein the sample needle can be moved out of this needle seat in order to receive sample. After the reintroduction of the sample needle into the needle seat the sample can be located in a fluid path which, for example by switching a valve, can be switched into the separation path of the system. In another exemplary embodiment of the present disclosure a sample injector or sampler can be used with a sample needle which is operated without a needle seat.

The analysis device can comprise a fraction collector for collecting the separated components. Such a fraction collector can guide the different components of the separated sample, for example into different liquid containers. However, the analyzed sample can also be supplied to a drain container.

The analysis device may comprise a detector for detecting the separated components. Such a detector can generate a signal which can be observed and/or recorded and which is indicative of the presence and quantity of the sample components in the fluid flowing through the system.

Embodiments of the present disclosure may be partly or entirely embodied or supported by one or more suitable software programs or products (or software), which may be stored on or otherwise provided by any kind of non-transitory medium or data carrier, and which may be executed in or by any suitable data processing unit such as an electronic processor-based computing device (or system controller, control unit, etc.) that includes one or more electronic processors and memories. Software programs or routines (e.g., computer-executable or machine-executable instructions or code) may be applied in or by the control unit, e.g. a data processing system such as a computer, such as for executing any of the methods described herein. For example, one embodiment of the present disclosure provides a non-transitory computer-readable medium that includes instructions stored thereon, such that when executed on a processor, the instructions perform or control one or more of the steps of the method of any of the embodiments disclosed herein.

### BRIEF DESCRIPTION OF THE DRAWINGS

Other objects and many of the attendant advantages of exemplary embodiments of the present disclosure will become readily apparent and better understood with reference to the following more detailed description of exemplary embodiments in conjunction with the accompanying drawings. Features which are substantially or functionally identical or similar are provided with the same reference signs.

FIG. 1 shows an analysis device configured as a sample separation device, according to an exemplary embodiment of the present disclosure.

FIG. 2 shows an analysis device system with an analysis device and a central control device, according to an exemplary embodiment of the present disclosure.

FIG. 3A shows a user interface for organizing the secondary functions of the analysis device, according to an exemplary embodiment of the present disclosure.

FIG. 3B shows another user interface for organizing the secondary functions of the analysis device, according to an exemplary embodiment of the present disclosure.

FIG. 3C shows another user interface for organizing the secondary functions of the analysis device, according to an exemplary embodiment of the present disclosure.

FIG. 4A shows another user interface for organizing the secondary functions of the analysis device, according to an exemplary embodiment of the present disclosure.

FIG. 4B shows another user interface for organizing the secondary functions of the analysis device, according to an exemplary embodiment of the present disclosure.

FIG. 4C shows another user interface for organizing the secondary functions of the analysis device, according to an exemplary embodiment of the present disclosure.

The illustrations in the drawings are schematic.

### DETAILED DESCRIPTION

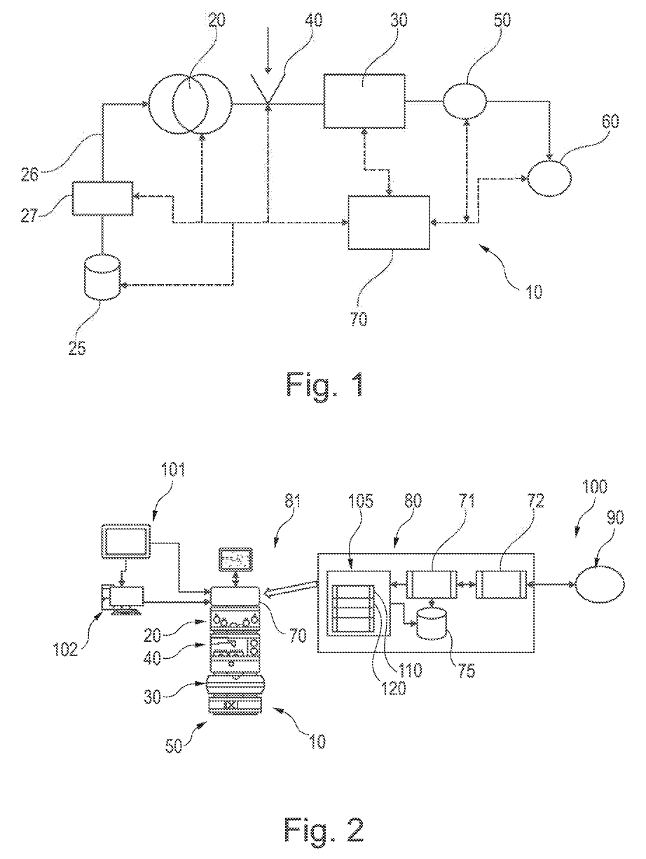

FIG. 1 shows the basic structure of an HPLC system as an example for an analysis device 10 configured as a sample separation device, according to an exemplary embodiment of the present disclosure, as it can be used for example for liquid chromatography. A fluid conveying device or a fluid drive 20 (such as an analytical pump), which is supplied with solvents from a supply device 25, drives a mobile phase through a sample separation device 30 (such as, for example, a chromatographic column) which includes a stationary phase. The supply device 25 comprises a first fluid component source for providing a first fluid or a first solvent component A (for example water) and a second fluid component source for providing another second fluid or a second solvent component B (for example an organic solvent). An optional degasser 27 can degas the solvents provided by means of the first fluid component source and by means of the second fluid component source before they are supplied to the fluid drive 20. Optionally, the solvents can be mixed at a mixing point.

A sample feed unit (or sample receptacle), which can also be referred to as injector 40, is arranged between the fluid drive 20 and the sample separation device 30 in order to receive a sample liquid or a fluidic sample from a sample container first into a sample receiving volume in an injector path, and subsequently by switching an injection valve of the injector 40 to introduce it into a fluidic separation path between fluid drive 20 and sample separation device 30. The receiving of fluidic sample from the sample container can take place in particular in that a sample needle is moved out of a sample seat and moved into the sample container, fluidic sample is sucked out of the sample container through the sample needle into the sample receiving volume by means of a fluid conveying device configured as a metering device, and the sample needle is then moved back into the needle seat.

The stationary phase of the sample separation device 30 is provided for separating components of the sample. A detector 50, which can comprise a flow cell, detects separated components of the sample. A fractionation device or fractionator 60 can be provided for outputting separated components of the sample into containers provided therefor. Liquids no longer required can be output into a drain container or into a waste line.

While a liquid path between the fluid drive 20 and the sample separation device 30 is typically under high pressure, the sample liquid is first introduced under normal pressure into a region separated from the liquid path, namely the sample loop or the sample receiving volume, of the sample feed unit or of the injector 40. Thereafter the sample liquid is introduced into the separation path under high pressure. A sample loop as sample receiving volume can denote a portion of a fluid line which is configured for receiving or temporarily storing a predefined quantity of fluidic sample. In an embodiment, even before the sample liquid in the sample receiving volume which is initially under normal pressure is switched into the separation path under high pressure, the content of the sample receiving volume is brought to the system pressure of the analysis device 10 configured as an HPLC by means of a metering device in the form of the fluid conveying device. A control unit 70 controls the individual components 20, 25, 30, 40, 50, 60, etc., of the analysis device 10. The control unit 70 can be provided as a central control device, as described in detail below, which enables inter alia a parallel operation of secondary functions.

FIG. 2 shows an analysis device system 100 with an analysis device 10 and a central control device 70 (e.g. hardware) as described above, according to an exemplary embodiment of the present disclosure. The analysis device 10 comprises the following four modules which are generally stacked on top of one another for reasons of space saving: fluid drive module 20, sample separation device module 30, injector module 40, and detector module 50. For performing the analysis (see detailed description of FIG. 1), the primary functions of the modules are used, which are thus directly associated with performing the analysis.

Additionally, however, secondary functions (e.g. a first secondary function 110 and a second secondary function 120) are also executed, which are indirectly associated with performing the analysis (i.e. do not comprise performing the analysis). The described analysis device 10 or the analysis device system 100 is characterized in particular in that at least two secondary functions are performed temporarily in parallel with one another.

In the example shown, the system control is centrally managed in the control device 70 via a central control software 80. This is accessible via a control system (e.g. assist hub) and can be operated by a user/operator by means of a local user interface 81 (which may be equipped with a browser). It is schematically shown that the control software 80 includes a task schedule 105 (task scheduler), in which secondary functions to be executed (running tasks) are organized and managed. For this purpose, a controller 71 can be used, which can be coupled to a database 75.

The control software 80 further comprises an interface to a network, e.g. a web server 72, so that a user 90 can also operate the analysis device 10 in remote operation. Additionally or alternatively, a user can also operate the control software 80 directly in remote operation, e.g. via a mobile end device 101 and/or a personal computer 102. In one example, user interfaces for control can also be integrated/implemented in a CDS (chromatography data system) (e.g. integrated on the PC).

In other words, the analysis device 10 contains a web server 72, which provides user interfaces 81, and a controller entity 71 for controlling the connection to the analysis device 10. With a locking mechanism, the required set of modules for a procedure is locked and when new procedures are started, it is checked whether the required modules are free. The web server 72 provides a user interface 81 which enables the user to navigate freely through diagnosis and maintenance procedures. Depending on the locked/unlocked modules, the user can start a procedure, e.g. the system pressure test, on a module, configure it and wait until it is completed. If desired, e.g. if the intervention takes a lot of time (e.g. the calibration operation can take 25 minutes), the user interface enables the navigation to another procedure on another module, e.g. the detector intensity test. The user can start the other operation and the device executes both in parallel. Between the operations, it can be switched until all/both are done. If user input is required, the controller entity can signal to the user that a specific operation needs attention.

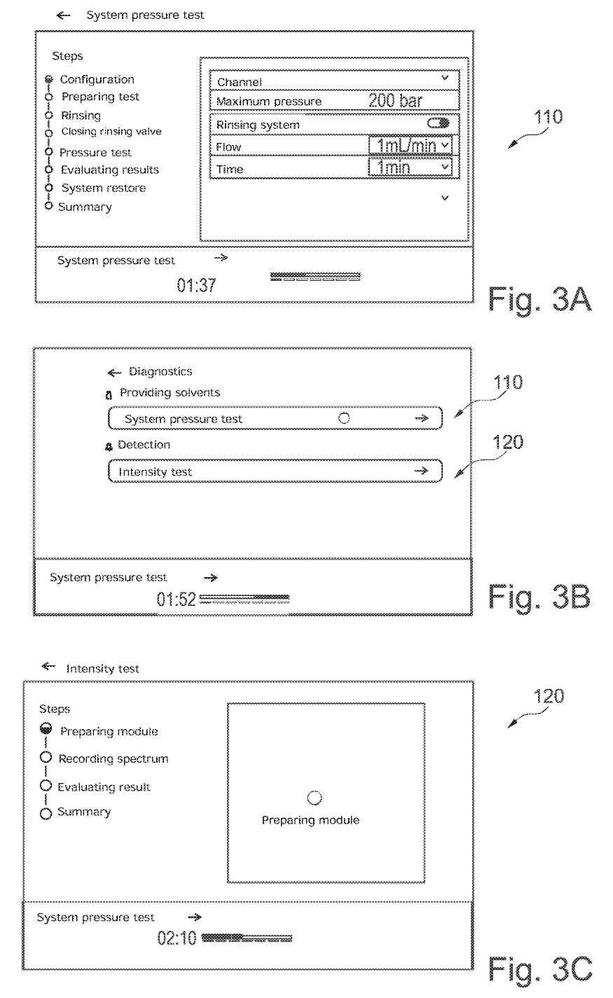

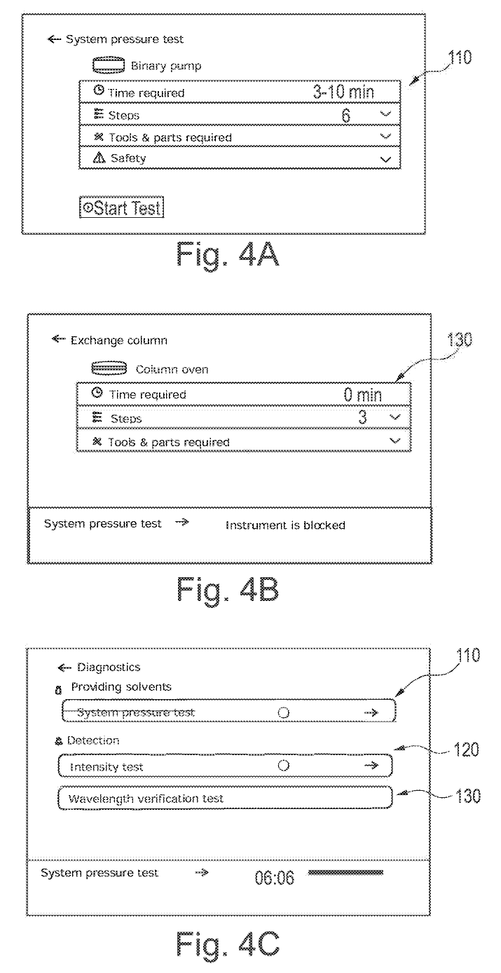

FIGS. 3A to 3C and 4A to 4C each show a possible user interface 81 for organizing the secondary functions of the analysis device, according to exemplary embodiments of the present disclosure.

FIG. 3A: the first secondary function 110 “system pressure test” is configured and started.

FIG. 3B: while the first secondary function 110 is already running, the user navigates to a second secondary function 120, the intensity test of the detector. While the system pressure test relates to the fluid drive module 20, the intensity test relates to the detector module 50. There is therefore no direct interaction between the first secondary function 110 and the second secondary function 120 (the resources/modules can be locked in the background).

FIG. 3C: the user starts the second secondary function 120, which is then executed temporarily in parallel/simultaneously with the first secondary function 110.

FIG. 4A: the first secondary function 110 “system pressure test” is configured. This system pressure test relates to the binary pump of the fluid drive module 20 and takes between 3 and 10 minutes. The user can now click on the start button (see below).

FIG. 4B: the user switches to a further secondary function 130, the exchanging of the sample separation device (separation column). The sample separation device is admittedly arranged in the sample separation module 30 and not in the fluid drive module 20; however, both modules 20, 30 are coupled to one another for testing the system pressure. Therefore, an execution of the secondary function will block both modules. Accordingly, the first secondary function 110 and the further secondary function 130 cannot be executed in parallel. Accordingly, the user cannot execute the start function. In the attempt nevertheless to start, he accordingly receives an error message.

FIG. 4C: the user instead starts the intensity test in the detector module 50 as second secondary function 120, which then runs in parallel to the system pressure test. The wavelength verification test likewise takes place in the detector module 50 and therefore cannot be performed as further parallel secondary function 130 to the intensity test.

It will be understood that one or more of the processes, sub-processes, and process steps described herein may be performed by hardware, firmware, software, or a combination of two or more of the foregoing, on one or more electronic or digitally-controlled devices. The software may reside in a software memory (not shown) in a suitable electronic processing component or system such as, for example, the control unit 70 schematically depicted in FIGS. 1 and 2. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which includes, for example, one or more microprocessors, general purpose processors, combinations of processors, digital signal processors (DSPs), application specific integrated circuits (ASICs), field-programmable gate array (FPGAs), etc. Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein that, when executed by a processing module of an electronic system (e.g., the control unit 70 schematically depicted in FIGS. 1 and 2), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

### REFERENCE SIGNS

10 Analysis device

20 Fluid drive

25 Supply device

27 Degasser

30 Sample separation device

40 Injector

50 Detector

60 Fractionator

70 Control device, hardware

71 Controller

72 Web server

75 Database

80 Control unit, software

81 User interface

90 User

100 Analysis device system

101 Mobile end device

102 Computer

105 Task schedule

110 First secondary function

120 Second secondary function

130 Further secondary function

1. An analysis device for performing an analysis, the analysis device configured to perform an operation comprising:
executing a primary function that is directly associated with performing the analysis; and
executing a first secondary function and a second secondary function that are indirectly associated with performing the analysis and/or are free from performing the analysis,
wherein the first secondary function and the second secondary function are performed at least temporarily in parallel with one another.

2. The analysis device according to claim 1, wherein the first secondary function and/or the second secondary function comprises at least one selected from the group consisting of:
a diagnosis; a maintenance; a fault search; a fault correction; a problem solution; a configuration; an adjusting; a calibration; an equilibration; a cleaning; a rinsing; a replacement; a repair; an adjustment; a test; a system test; a function test; a system check; and a function check.

3. The analysis device according to claim 1, wherein the primary function comprises a direct reference to the analysis of a sample and comprises at least one of the following:
operating an analytical pump; operating a sample separation device; operating a sample receptacle; operating a detector.

4. The analysis device according to claim 1, wherein the analysis device comprises at least one of the following:
two or more modules of the following modules: a pump module; a detector module; a sample separation module; a sample receptacle module;
at least one of the following modules: a pump module; a detector module; a sample separation module; a sample receptacle module.

5. The analysis device according to claim 1, wherein the first secondary function and the second secondary function relate to different functions and/or different processes and/or different modules of the analysis device.

6. The analysis device according to claim 1, wherein the operation comprises:
determining which function of the analysis device is required by the first function and/or second secondary function; and
blocking this function for a further secondary function as long as the first function and/or second secondary function is executed.

7. The analysis device according to claim 1, wherein the operation comprises:
determining which module and/or which component is required by the first function and/or second secondary function; and
blocking this module and/or this component for a further secondary function as long as the first function and/or second secondary function is executed.

8. The analysis device according to claim 1, wherein the operation comprises at least one of:
comparing the first secondary function and the second secondary function;
comparing the first secondary function and the second secondary function such that an action that has already been performed for the first secondary function is obsolete for the second secondary function.

9. The analysis device according to claim 1, wherein the operation comprises at least one of:
performing a scheduling with respect to the first secondary function and the second secondary function;
performing a scheduling with respect to when the first secondary function and/or the second secondary function is available again.

10. The analysis device according to claim 1, wherein the operation comprises at least one of:
determining whether a further secondary function is active that may interfere with executing the first secondary function and/or the second secondary function;
determining whether a further secondary function is active that may interfere with executing the first secondary function and/or the second secondary function, and performing the first secondary function and/or the second secondary function after the further secondary function has been performed.

11. The analysis device according to claim 1, wherein the operation comprises at least one of:
influencing a flow path of the analysis device;
influencing a flow path of the analysis device by at least one of following to enable the secondary functions to be executed in parallel: blocking; diverting; coupling or decoupling; retracting or extending; interconnecting.

12. The analysis device according to claim 1, comprising a central control device, wherein:
the first secondary function and the second secondary function are organized in the central control device; and/or
the primary function is organized in the central control device.

13. The analysis device according to claim 1, wherein the analysis device or the central control device comprises control software comprising a user interface by which a user can organize the secondary functions and/or the primary functions, and wherein the user interface enables at least one of the following:
detecting whether a secondary function is available or blocked;
detecting when the execution of the first secondary function and/or the second secondary function will be completed;
receiving a notification when a secondary function is completed and/or available again.

14. The analysis device according to claim 1, wherein the analysis device and/or the central control device are configured to be operated at least partially in remote operation via a network.

15. The analysis device according to claim 1, wherein at least two of the following secondary functions are executed at least temporarily in parallel:
calibrating an analytical pump of the analysis device;
exchanging a sample needle and/or a needle seat of the analysis device;
performing an intensity test of a detector lamp of the analysis device.

16. The analysis device according to claim 1, further comprising at least one of the following features:
the analysis device comprises a fluid drive configured to drive a mobile phase and a fluidic sample injected into the mobile phase;
the analysis device comprises a sample separation device configured to separate the fluidic sample injected into the mobile phase;
the analysis device is configured to analyze at least one physical, chemical and/or biological parameter of the fluidic sample;
the analysis device is configured as a sample separation device configured to separate the fluidic sample;
the analysis device has a configuration selected from the group consisting of: a chromatography device; a liquid chromatography device; a gas chromatography device; a supercritical liquid chromatography device; and a high-performance liquid chromatography device;
the analysis device is configured as a microfluidic device;
the analysis device is configured as a nanofluidic device;
the sample separation device is configured as a chromatographic separation device;
the fluid drive is configured to drive the mobile phase and the fluidic sample at a pressure selected from the group consisting of: at least 500 bar; at least 1000 bar; at least 1200 bar;
the analysis device comprises a detector configured to detect the separated fluidic sample;
the analysis device comprises a fractionator configured to fractionate separated fractions of the fluidic sample.

17. A method for operating an analysis device, the method comprising:
executing a primary function that is directly associated with performing the analysis; and
executing a first secondary function and a second secondary function that are indirectly associated with performing the analysis and/or are free from performing the analysis,
wherein the first secondary function and the second secondary function are performed at least temporarily in parallel with one another.

18. A device for data processing that is configured to carry out the method according to claim 17.
